(19) United States
(12) Patent Application Publication
(10) Pub. No.: US 2010/0201786 A1
(43) Pub. Date: Aug. 12, 2010

(54) METHOD AND APPARATUS FOR RECONSTRUCTING AN IMAGE

(75) Inventors: Dirk Schaefer, Hamburg (DE); Michael Grass, Buchholz In Der Nordheide (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,185

(22) PCT Filed: May 3, 2007
(86) PCT No.: PCT/IB2007/051650

§ 371 Date: Nov. 10, 2008

(30) Foreign Application Priority Data
May 11, 2006 (EP) 06113805.3

(51) Int. Cl. H04N 13/02; G06K 9/00

(52) U.S. Cl. 348/47; 382/154; 348/E13.074

(57) ABSTRACT

A reconstruction method for an image of an object under examination is provided, wherein the method comprises, receiving a first projection data set representing three-dimensional information about said object under examination and reconstructing at least one three-dimensional image out of the first projection data set. Further, a second projection data set representing two-dimensional information about the object under examination is received, wherein the second data set was recorded under a first direction and wherein a two-dimensional image out of the second projection data set is generated. Furthermore, a volume rendered projection is reconstructed out of the at least one three-dimensional image using the first direction as the reconstruction direction of the volume rendered projection and the two-dimensional image and the volume rendered projection are overlaid.

The invention relates to a method and an apparatus for reconstructing an image of an object under examination, a method and a system for imaging an object under examination, a computer readable medium and a program element. In particular, the invention relates to a method and an apparatus for reconstructing a channel in the object under examination for a 4D roadmapping.

From the prior art several methods for reconstructing images of an object under examination are known. Such images may be used for forming maps or roadmaps to be associated with current X-ray images. These images may be used during an invasive vascular intervention. For example, during a coronary intervention the physician navigates within the coronary tree by using multiple injections of contrast agent. In this way, the position of a guide wire and a catheter become visible relative to the vessels. From the prior art methods are known to model the coronary centreline tree from a single rotational X-ray coronary angiography acquisition and enable a subsequent motion compensated reconstruction of the coronary arteries. These reconstructions of coronary arteries may be subsequently used as roadmapping information for a coronary intervention.

However, it may be desirable to provide an alternative method and an apparatus for reconstructing an image of an object under examination, a method and a system for imaging an object under examination, a computer readable medium and a program element which may be more flexible and/or may provide improved navigation support.

This need may be met by a method and an apparatus for reconstructing an image of an object under examination, a method and a system for imaging an object under examination, a computer readable medium and a program element according to the independent claims.

According to an exemplary embodiment a reconstruction method for an image of an object under examination is provided, wherein the method comprises, receiving a first projection data set representing three-dimensional information about said object under examination and reconstructing at least one three-dimensional image out of the first projection data set. Further, a second projection data set representing two-dimensional information about the object under examination is received, wherein the second data set was recorded under a first direction and wherein a two-dimensional image out of the second projection data set is generated. Furthermore, a volume rendered projection is reconstructed out of the at least one three-dimensional image using the first direction as the reconstruction direction of the volume rendered projection and furthermore the two-dimensional image and the volume rendered projection are overlaid.

According to an exemplary embodiment an imaging method for an object under examination comprises recording a first projection data set representing three-dimensional information about said object under examination and recording a second projection data set representing two-dimensional information about the object under examination, wherein the second data set is recorded under a first direction. Furthermore, the first projection data set and the second projection data set are used as the first projection data set and the second projection data set, respectively, in a reconstruction method according to an exemplary embodiment of the present invention. In particular, the first and second projection data sets might be taken by using X-ray devices, like an X-ray C-arm for the first projection data set and/or an X-ray fluoroscopy device for the second projection data set.

According to an exemplary embodiment an apparatus for reconstructing an image of an object under examination comprises a receiving unit, a reconstruction unit, and an overlaying unit, wherein the receiving unit is adapted to receive a first projection data set representing three-dimensional information about said object under examination and to receive a second projection data set representing two-dimensional information about the object under examination, wherein the second data set was recorded under a first direction. Further, the reconstructing unit is adapted to reconstruct at least one three-dimensional image out of the first projection data set, wherein the reconstruction unit is further adapted to reconstruct a volume rendered projection out of the at least one three-dimensional image using the first direction as the reconstruction direction of the volume rendered projection and to generate a two-dimensional image out of the second projection data set. Furthermore, the overlaying unit is adapted to overlay the two-dimensional image and the volume rendered projection.

According to an exemplary embodiment a system for generating an image of an object under examination comprises a first scanning unit, a second scanning unit, and an apparatus for reconstructing an image according to an exemplary embodiment of the invention. Further, the first scanning unit is adapted to record a first projection data set representing three-dimensional information about said object under examination. Furthermore, the second scanning unit is adapted to record a second projection data set representing two-dimensional information about the object under examination, wherein the second data set is recorded under a first direction. It should be noted that the first scanning unit and the second scanning unite may be one single device, e.g. an X-ray C-arm, or may be two separate devices.

According to an exemplary embodiment of a computer readable medium is provided, in which a program for reconstructing an image of an object under examination is stored, which program, when executed by a processor, is adapted to control a method comprising receiving a first projection data set representing three-dimensional information about said object under examination and reconstructing at least one three-dimensional image out of the first projection data set. Further the method comprises receiving a second projection data set representing two-dimensional information about the object under examination, wherein the second data set was recorded under a first direction, and generating a two-dimensional image out of the second projection data set. Furthermore, the method comprises reconstructing a volume rendered projection out of the at least one three-dimensional image using the first direction as the reconstruction direction of the volume rendered projection, and overlaying the two-dimensional image and the volume rendered projection.

According to an exemplary embodiment a program element for reconstructing an image of an object under examination is provided, which program, when executed by a processor, is adapted to control a method comprising receiving a first projection data set representing three-dimensional information about said object under examination and reconstructing at least one three-dimensional image out of the first projection data set. Further the method comprises receiving a second projection data set representing two-dimensional information about the object under examination, wherein the second data set was recorded under a first direction, and generating a two-dimensional image out of the second projection data set. Furthermore, the method comprises reconstructing a volume rendered projection out of the at least one three-dimensional image using the first direction as the reconstruction direction of the volume rendered projection, and overlaying the two-dimensional image and the volume rendered projection.

It may be seen as the gist of an exemplary embodiment of the present invention that one or more reconstructed three-dimensional images may be used for the reconstruction of an object under examination, in particular to reconstruct an inner channel system or an inner chamber system of the object under examination. Such a channel system may be a so called coronary tree, i.e. the vessels surrounding a heart of a patient. An inner chamber system may be, for example, a ventricle or an aneurysma of a vessel of a patient. This reconstructed inner channel system or chamber system may be used as a roadmap for the two-dimensional projections, e.g. for two-dimensional X-ray fluoroscopy projections.

When using an imaging and/or reconstruction method according to an exemplary embodiment for the roadmapping of a coronary intervention the method may be suitable to provide a four-dimensional roadmapping for the coronary intervention. When using such a method the required amount of contrast agent may be reducible and a real time feedback of the overlaid three-dimensional information of the three-dimensional image may support the navigation in the coronary tree or chamber system, e.g. the navigation of a guide wire. In particular, the physician may be completely free in the choice of the angles for taking the projection data sets for the two-dimensional image, e.g. a fluoroscopy projection. In particular, the angle may not coincide with a projection angle at which the first projection data set is measured, e.g. a standard rotational angiography, which may be measured under the influence of a contrast agent in the coronary tree of a patient. While, according to the two-dimensional time-dependent roadmapping methods known in the prior art, the physician may not be free in choice in choosing the angle of the fluoroscopy projection and this angle may have to coincide with the projection angle used while measuring with the contrast agent.

In particular, it may be possible to reduce the inconsistencies between the volume rendered projection and the generated two-dimensional image when the first projection data set and the second projection data set are recorded using the same device, like an X-ray C-arm. In that case it may be possible that no registering of the volume rendered projection and the generated two-dimensional image is necessary in order to overlay the both.

In the following, further exemplary embodiments of the reconstruction method will be described. However, these embodiments apply also for the imaging method, the apparatus for reconstructing an image, the system for generating an image, the computer readable medium and the program element.

A Maximum Intensity Projection (MIP) is a known computer visualization method for three-dimensional data (images) that projects in the visualization plane the voxels, i.e. three-dimensional image pixel, with maximum intensity that fall in the way of parallel rays traced from the viewpoint to the plane of projection. That is, MIP is a volume rendering technique which is used to visualize structures within volumetric data. At each pixel the highest data value, which is encountered along a corresponding viewing ray is depicted.

According to another exemplary embodiment of the reconstruction method the first projection data set is recorded by an X-ray C-arm. Preferably, the second projection data set is also recorded by an X-ray C-arm.

According to another exemplary embodiment of the reconstruction method the volume rendered projection is a Maximum Intensity Projection. Alternatively other volume rendered projections, or projections of boundary areas of a segmented structure within the volumetric data, like a heart of a patient, may be used.

According to another exemplary embodiment of the reconstruction method the first projection data set was recorded at a time the object under examination was under influence of a contrast agent. Preferably, the second projection data set was recorded at a time the object under examination was not under influence of a contrast agent.

By using a contrast agent when the first projection data set is recorded or measured it may be possible to reconstruct structures of the three-dimensional image or images in an efficient way. In particular, it may be possible to reconstruct structures which might not be visible without the using of a contrast agent, like channels in an object under examination, in particular vessels of a patient, like a coronary tree. From these data one or more three-dimensional image of the object under examination may be reconstructable, in particular, the channel system or coronary tree system or chamber system, which might be usable for roadmapping, e.g. in a coronary intervention. The tracking of a guide wire may be possible by recording a second projection data set without the usage of a contrast agent on an X-ray image, like a fluoroscopy projection, thus possibly leading to a decrease in usage of contrast agent. The volume rendered projection generated out of the three-dimensional image may be overlaid with the two-dimensional fluoroscopic projection.

According to another exemplary embodiment the reconstruction method further comprises the performing of a registration of the volume rendered projection and the two-dimensional images before overlaying the both. The registration may be an rigid registration or a non-rigid registration. A non-rigid registration may be a landmark-based elastic registration or an intensity-based elastic registration, wherein the landmark-based elastic registration may be a point-landmark based elastic registration, using thin plate splines, a curves-landmark based elastic registration, a surfaces-landmark based elastic registration, or a volume-landmark based elastic registration.

In particular, using a rigid registration it might be possible to eliminate or at least reduce motion inconsistencies. These motion inconsistencies may be induced by breathing, in case the object under examination is a patient or the heart of a patient. Image registration, which is also called image matching, is well known to the person skilled in the art and refers to the task to compute spatial transformations, which map each point of an image onto its (physically) corresponding point of another image. In case the first projection data set and the second projection data set is recorded by using a different device, a registration for matching the volume rendered projection and the two-dimensional image is advantageous or even might be necessary in order to match the both so that they can be overlaid.

According to another exemplary embodiment the reconstruction method further comprises receiving a third data set representing motion related information of the object under examination. Preferably, the third data set represents a periodic motion. In case of a coronary intervention, the third data set may preferably be measured by an electrocardiogram device, i.e. the third data set may represent electrocardiogram data. The third data set may as well be measured by any other method which can measure a specific cardiac phase.

According to another exemplary embodiment of the reconstruction method each three-dimensional image is motion compensated by using the motion information of the third data set. In case of a coronary intervention preferably for each distinguishable heart phase a motion-compensated three-dimensional image is reconstructed or calculated. This is preferably done by using a filtered back-projection algorithm, which may be a fast way to calculate the back-projection. In particular, this might be a fast and efficient way to perform the back-projection, since only voxels, i.e. three-dimensional image pixels, near to the determined and thus known centrelines of the channel system, e.g. a coronary tree system, have to be reconstructed. These may reduce the amount of voxels to be reconstructed to about only 5% of all voxels which covering the whole volume measured and represented by the first projection data set. Such a filtered back-projection algorithm is known from “Motion compensated cone beam filtered back-projection for 3D rotational X-ray angiography: A simulation study”. D. Schafer et al., Proc. of the Conference on Fully 3D Reconstruction in Radiology and Nuclear Medicine, F. Noo, editor, Salt Lake City, USA, pp. 360-363. However, the motion-compensation may as well be performed by using methods not relaying on the third data set, e.g. the motion compensation may be performed by information deducible from the first projection data set itself.

According to another exemplary embodiment the reconstruction method further comprises reconstructing a plurality of three-dimensional images out of the first projection data set. In particular, each of the three-dimensional images, may be motion compensated. Preferably, each of the plurality of three-dimensional images is associated to a specific motion state of the object under examination, e.g. to a specific cardiac phase, in case the reconstructed image may be used in a coronary intervention.

By providing a plurality of possibly motion-compensated three-dimensional images, it may be possible to generate volume rendered projections, e.g. Maximum Intensity Projections, for several specific motion states, e.g. cardiac phases.

According to another exemplary embodiment of the reconstruction method the volume rendered projection and the two dimensional image are associated to the same motion state of the object under examination.

In the following, further exemplary embodiments of the system for generating an image will be described. However, these embodiments apply also for the imaging method, the apparatus for reconstructing an image, the reconstruction method, the computer readable medium and the program element.

According to another exemplary embodiment the first scanning unit is an X-ray C-arm, and/or the second scanning unit is a fluoroscopy apparatus. In particular, the first scanning unit and the second scanning unit may be a single scanning unit, e.g. an X-ray C-arm.

It should be noted in this context, that the present invention is not limited to a C-arm based 3D rotational X-ray imaging, but may be usable in a computer tomography, magnetic resonance imaging, positron emission tomography or the like. It should also be noted that this technique may in particular be useful for medical imaging like diagnosis of the heart or lungs of a patient.

The examination of the object of interest, e.g. the analysis and reconstruction of cardiac C-arm based 3D rotational X-ray imaging taken by a scanning unit and/or a computer tomography apparatus, may be realized by a computer program, i.e. by software, or by using one or more special electronic optimization circuits, i.e. in hardware, or in hybrid form, i.e. by software components and hardware components. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

It may be seen as the gist of an exemplary embodiment of the present invention that a time-dependent set of motion-compensated three-dimensional reconstructions of a coronary tree is used as a roadmap for two-dimensional X-ray fluoroscopy projections. The method may require the following steps:
A standard rotational angiography acquisition is performed while the vessels of interest of a patient are filled with a contrast agent. An electrocardiogram is measured, or any other method is applied, to correlate the projections to a specific cardiac phase. For each distinguishable heart phase, a motion-compensated reconstruction is calculated. This can be done in a fast way by using a filtered back-projection algorithm, because only the voxels near to the known centrelines have to be reconstructed (i.e. only about 5% of the voxels covering the whole volume).
According to the viewing direction of the fluoroscopic projection without contrast agent and the cardiac phase determined by the electrocardiogram signal, a Maximum Intensity Projection of the appropriate motion-compensated reconstruction of the same cardiac phase is calculated. The Maximum Intensity Projection and the fluoroscopic projection are overlaid. Residual motion inconsistencies, e.g. caused by breathing, can be eliminated by rigid registration. A guide wire can be tracked in the fluoroscopy projections, and registered to the Maximum Intensity Projection of the motion-compensated reconstruction.

The method according to this exemplary embodiment may be used as a four-dimensional roadmapping for coronary interventions, e.g. in the displaying of roadmapping information. When using this method the required amount of contrast agent may be reduced and it may be that a real-time feedback of the overlaid three-dimensional information support the navigation in the coronary intervention, e.g. the navigation of a guide wire. The physician may be completely free in the choice of the angles of the fluoroscopy projections, which not necessarily coincide with a projection angle measured with contrast agent, as opposed to existing two-dimensional time-dependent roadmapping methods, known in the prior art.

It should be noted that all different embodiments and aspects of the invention described anywhere in this application may be mixed and/or combined. These and other aspects of the present invention will become apparent from and elucidated with reference to the embodiment described hereinafter.

An exemplary embodiment of the present invention will be described in the following, with reference to the following drawings.

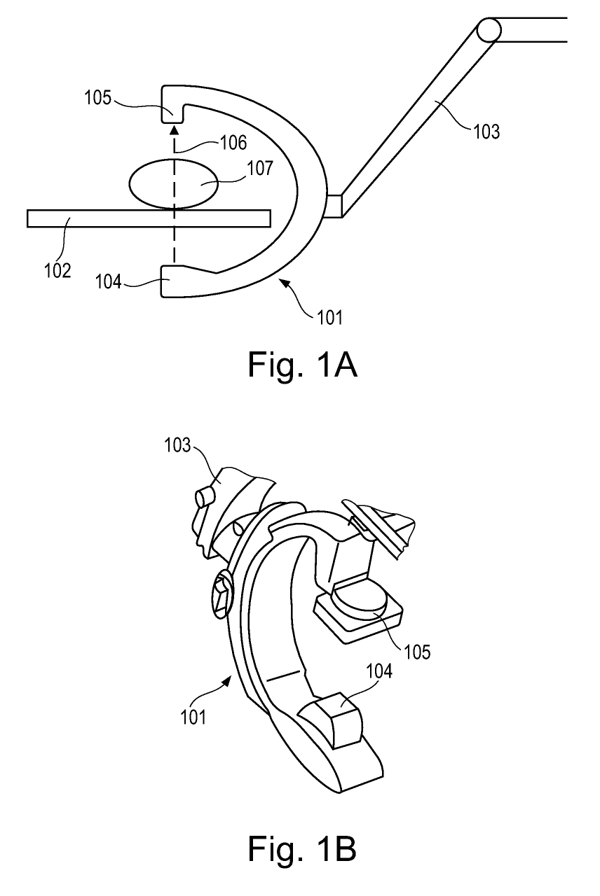

FIG. 1 shows a simplified schematic representation of an X-ray C-arm system.

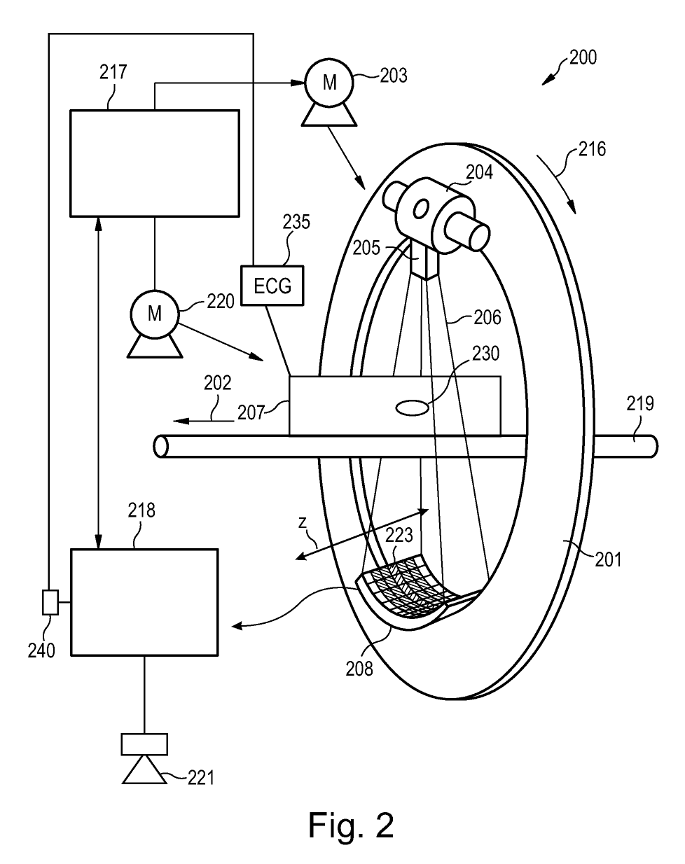

FIG. 2 shows a simplified schematic representation of a computer tomography device.

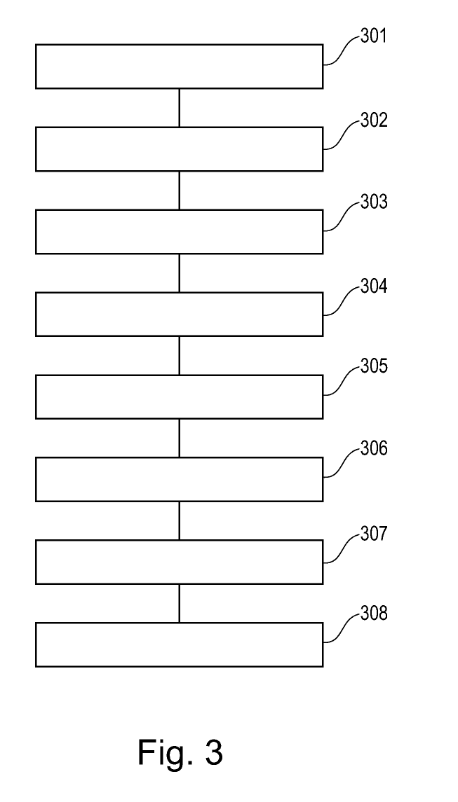

FIG. 3 shows a schematic flowchart of an imaging method according to an exemplary embodiment.

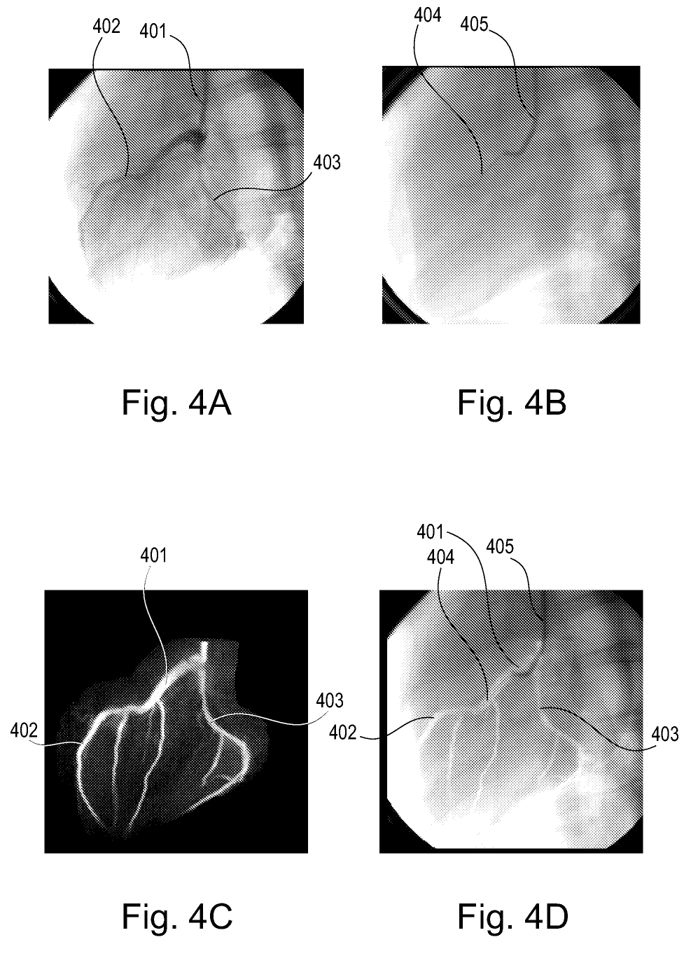

FIG. 4 shows schematic images of a coronary vessel system generated according to a reconstruction method according to an exemplary embodiment.

The illustration in the drawings is schematically. In different drawings, similar or identical elements are provided with the similar or identical reference signs.

FIG. 1 shows an exemplary embodiment of a simplified schematic representation of a X-ray C-arm system. The X-ray C-arm system comprises a swing arm scanning system (C-Arm or G-Arm) 101 supported proximal a patient table 102 by a robotic arm 103. Housed within the swing arm 101, there is provided an X-ray tube 104 and an X-ray detector 105, the X-ray detector 105 being arranged and configured to receive X-rays 106 which have passed through an object under examination 107, e.g. a patient, and generate an electrical signal representative of the intensity distribution thereof. By moving the swing arm 101 and the robotic arm 103, the X-ray tube 104 and detector 105 can be placed at any desired location and orientation relative to the patient 107.

FIG. 2 shows a schematic representation of a computer tomography apparatus 200. The computer tomography apparatus 200 depicted in FIG. 2 is a cone-beam CT scanner. The CT scanner depicted in FIG. 2 comprises a gantry 201, which is rotatable around a rotational axis 202. The gantry 201 is driven by means of a motor 203. Reference numeral 204 designates a source of radiation such as an X-ray source, which emits polychromatic or monochromatic radiation.

Reference numeral 205 designates an aperture system which forms the radiation beam emitted from the radiation source unit to a cone-shaped radiation beam 206. The cone-beam 206 is directed such that it penetrates an object of interest 207 arranged in the center of the gantry 201, i.e. in an examination region of the CT scanner, and impinges onto the detector 208 (detection unit). As may be taken from FIG. 2, the detector 208 is arranged on the gantry 201 opposite to the radiation source unit 204, such that the surface of the detector 208 is covered by the cone beam 206. The detector 208 depicted in FIG. 2 comprises a plurality of detection elements 223 each capable of detecting X-rays which have been scattered by, attenuated by or passed through the object of interest 207. The detector 208 schematically shown in FIG. 2 is a two-dimensional detector, i.e. the individual detector elements are arranged in a plane, such detectors are used in so called cone-beam tomography.

During scanning the object of interest 207, the radiation source unit 204, the aperture system 205 and the detector 208 are rotated along the gantry 101 in the direction indicated by an arrow 216. For rotation of the gantry 201 with the radiation source unit 204, the aperture system 205 and the detector 208, the motor 203 is connected to a motor control unit 217, which is connected to a control unit 218. The control unit might also be denoted as a calculation, reconstruction, overlaying or determination unit and might be implemented by way of a computer or processor.

Optionally, an electrocardiogram device 235 can be provided which measures an electrocardiogram of the heart 230 of the human being 207 while X-rays attenuated by passing the heart 230 are detected by detector 208. The data related to the measured electrocardiogram are transmitted to the control unit 218.

The detector 208 is connected to the control unit 218. The control unit 218 receives the detection result, i.e. the read-outs from the detection elements 223 of the detector 208 and determines a scanning result on the basis of these read-outs. Furthermore, the control unit 218 communicates with the motor control unit 217 in order to coordinate the movement of the gantry 201 with motors 203 and 220 with the operation table 219.

The control unit 218 may be adapted for reconstructing an image from read-outs of the detector 208. A reconstructed image generated by the control unit 218 may be output to a display (not shown in FIG. 2) via an interface 222.

The control unit 218 may be realized by a data processor to process read-outs from the detector elements 223 of the detector 208.

The computer tomography apparatus shown in FIG. 2 may capture multi-cycle cardiac computer tomography data of the heart 230. In other words, when the gantry 201 rotates and when the operation table 219 is shifted linearly, then a helical scan is performed by the X-ray source 204 and the detector 208 with respect to the heart 230. During this helical scan, the heart 230 may beat a plurality of times and multiple RR-cycles are covered. During these beats, a plurality of cardiac computer tomography data are acquired. Simultaneously, an electrocardiogram may be measured by the electrocardiogram unit 235. After having acquired these data, the data are transferred to the control unit 218, and the measured data may be analyzed retrospectively.

In the following the imaging and reconstruction method according to an exemplary embodiment of the invention will be described under reference to the flowchart schematically depicted in FIG. 3.

Firstly, a first projection data set is recorded 301 representing three-dimensional information about an object under examination, e.g. a coronary vessel system of a patient. Preferably, this first projection data set is measured by an X-ray apparatus, e.g. an X-ray C-Arm device. In order to more clearly measuring the coronary vessels a contrast agent is used. Simultaneously, a third data set may be recorded 302 which is indicative for a movement of the object under examination during the taking of the first projection data set 302. The third data set may be measured using an electrocardiogram device. From this first projection data set and the third data set motion-compensated three-dimensional images are reconstructed 303. Preferably, for every cardiac phase of interest, e.g. every specific cardiac phase, one three-dimensional image is reconstructed by using a filtered back-projection algorithm.

Afterwards, a second projection data set is measured 304 using a fluoroscopy device, like a standard X-ray apparatus. The second projection data set is taken at a predetermined first direction, which may be chooseable freely by a physician in case of a coronary intervention. Afterwards, a two-dimensional image of the object under examination may be generated 305, e.g. of the coronary region of a patient. Since, the second projection data set preferably is recorded without the use of a contrast agent, only dense parts, like guide wires, are clearly visible on the generated two-dimensional image. Therefore, from the three-dimensional images one is chosen representing the same motion state, e.g. cardiac phase, as the two-dimensional image and a Maximum Intensity Projection (MIP) is generated from this chosen three-dimensional image 306. This MIP is made by using the chosen first direction at which the second projection data set is recorded.

Afterwards, the reconstructed MIP and the generated two-dimensional image are preferably registered which may reduce inconsistencies between the two images due to residual motions 307. Then the registered MIP and the registered two-dimensional image can be overlaid 308. Leading to an image on which the vessel system as well as a guide wire may be clearly visible. This image may be used by the physician as a roadmap. During a coronary intervention several two-dimensional images may be taken and reconstructed, i.e. several second projection data sets may be recorded by the fluoroscopy device. These two-dimensional images may be all overlaid with a suitable MIP, e.g. a MIP which corresponds to the directions and the cardiac phase the fluoroscopy projections are taken. Thus, the physician may observe the advance of the coronary intervention, like the advancing of a guide wire in the coronary vessel system.

FIG. 4 shows schematic images of a coronary vessel system generated according to a reconstruction method according to an exemplary embodiment.

FIG. 4A schematically shows an image of a thorax of a patient, taken by a rotational coronary angiography. During the rotational coronary angiography a contrast agent was injected into the vessels of interest, which can be seen as dark lines 401, 402 and 403 in the image shown in FIG. 4A.

FIG. 4B schematically shows a fluoroscopic projection with guide wire and catheter present in the coronary vessel tree. Since this image was recorded without contrast agent being present in the vessel system, the vessels are practically unseeable in FIG. 4B, while the guide wire and catheter can be seen as dark line 404 and 405, respectively, in FIG. 4B.

FIG. 4C schematically shows a reconstructed Maximum Intensity Projection (MIP) which was generated for the same direction as the fluoroscopy projection shown in FIG. 4B was taken. This MIP is generated from a motion-compensated three-dimensional image reconstructed from the rotational coronary angiography of FIG. 4A. Due to the choosing of the voxels having the highest intensity along the path of the beam along the chosen direction the vessel system having vessels 401, 402 and 403 can be clearly seen in FIG. 4C.

FIG. 4D schematically shows an image generated by overlaying FIGS. 4B and 4C, i.e. shows an overlay of motion-compensated MIP of FIG. 4C and fluoroscopy projection of FIG. 4B. In this image the vessels 401, 402 and 403 can be seen as well as the guide wire and catheter 404. By using such an image as shown in FIG. 4D a physician can see the advancing of the guide wire in a coronary vessel tree of the patient. Thus, this method can be used as a four-dimensional roadmapping for a coronary intervention. In particular, several fluoroscopy projection can be recorded and reconstructed during a coronary intervention during different time instants. In case these several fluoroscopy projections are overlaid with MIPs the advancing of the guide wire is clearly visible to the physician.

Summarizing, it may be seen as an aspect of the present invention that a first projection data set is recorded at a time the object under examination is under the influence of a contrast agent. Out of this projection data set one or a plurality of preferably motion-compensated three-dimensional images is reconstructed showing channels in the object under examination. From at least one out of this plurality of three-dimensional images a Maximum Intensity Projection is generated having the viewing direction which is the same at which a second projection data set representing information of a two-dimensional image of the object under examination is taken. After generation of the two-dimensional image and registration the same with the MIP the two images are overlaid. Thus, it may be said, that a three-dimensional reconstruction of the object under examination and in particular of cannels in this object may be created, from which a MIP can be generated having each desired direction. In particular, it may be possible to reconstruct this three-dimensional model from one single measuring run, thus may lead to an decrease in computing power and measuring time as well as an decrease in exposure time of the object under examination and an decrease in contrast agent.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A reconstruction method for an image of an object under examination, the method comprising:
receiving a first projection data set representing three-dimensional information about said object under examination;
reconstructing at least one three-dimensional image out of the first projection data set;
receiving a second projection data set representing two-dimensional information about the object under examination, wherein the second data set was recorded at a first direction;
reconstructing a volume rendered projection out of the at least one three-dimensional image using the first direction as the reconstruction direction of the volume rendered projection;
generating a two-dimensional image out of the second projection data set; and
overlaying the two-dimensional image and the volume rendered projection.

2. The reconstruction method according claim 1,
wherein the first projection data set is recorded by an X-ray C-arm.

3. The reconstruction method according claim 1 or 2,
wherein the volume rendered projection is a Maximum Intensity Projection.

4. The reconstruction method according to anyone of the preceding claims;
wherein the first projection data set was recorded at a time the object under examination was under influence of a contrast agent.

5. The reconstruction method according to anyone of the preceding claims;
wherein the second projection data set was recorded at a time the object under examination was not under influence of a contrast agent.

6. The reconstruction method according to anyone of the preceding claims: further comprising:
performing a registration of the volume rendered projection and the two-dimensional image before overlaying the both.

7. The reconstruction method to anyone of the preceding claims, further comprising:
receiving a third data set representing motion related information of the object under examination.

8. The reconstruction method according claim 7,
wherein the third data set represents a periodic motion.

9. The reconstruction method according to claim 7 or 8,
wherein each three-dimensional image is motion compensated in particular by using the motion information of the third data set.

10. The reconstruction method according to anyone of the preceding claims,
wherein the reconstruction of the at least one three-dimensional image is done by using a filtered back-projection algorithm.

11. The reconstruction method according to anyone of the preceding claims, further comprising:
reconstructing a plurality of three-dimensional images out of the first projection data set.

12. The reconstruction method according claim 11,
wherein each of the plurality of three-dimensional images is associated to a specific motion state of the object under examination.

13. The reconstruction method according to claim 12,
wherein the volume rendered projection and the two dimensional image are associated to the same motion state of the object under examination.

14. Imaging method for an object under examination, the method comprising:
recording a first projection data set representing three-dimensional information about said object under examination;
recording a second projection data set representing two-dimensional information about the object under examination, wherein the second data set is recorded under a first direction; and
the reconstruction method according to anyone of the claims 1 to 13.

15. Apparatus for reconstructing an image of an object under examination, the apparatus comprising:
a receiving unit;
a reconstruction unit; and
an overlaying unit;
wherein the receiving unit is adapted to receive a first projection data set representing three-dimensional information about said object under examination and to receive a second projection data set representing two-dimensional information about the object under examination, wherein the second data set was recorded under a first direction;
wherein the reconstructing unit is adapted to reconstruct at least one three-dimensional image out of the first projection data set, wherein the reconstruction unit is further adapted to reconstruct a volume rendered projection out of the at least one three-dimensional image using the first direction as the reconstruction direction of the volume rendered projection and to generate a two-dimensional image out of the second projection data set; and
wherein the overlaying unit is adapted to overlay the two-dimensional image and the volume rendered projection.

16. System for generating an image of an object under examination, the system comprising:
a first scanning unit;
a second scanning unit; and
an apparatus for reconstructing an image according to claim 15,
wherein the first scanning unit is adapted to record a first projection data set representing three-dimensional information about said object under examination; and
wherein the second scanning unit is adapted to record a second projection data set representing two-dimensional information about the object under examination, wherein the second data set was recorded at a first direction.

17. The system according claim 16;
wherein the first scanning unit is an X-ray C-arm, and/or
wherein the second scanning unit is a fluoroscopy apparatus.

18. A computer readable medium in which a program for reconstructing an image of an object under examination is stored, which program, when executed by a processor, is adapted to control a method comprising:
receiving a first projection data set representing three-dimensional information about said object under examination;
reconstructing at least one three-dimensional image out of the first projection data set;
receiving a second projection data set representing two-dimensional information about the object under examination, wherein the second data set was recorded at a first direction;
reconstructing a volume rendered projection out of the at least one three-dimensional image using the first direction as the reconstruction direction of the volume rendered projection;
generating a two-dimensional image out of the second projection data set; and
overlaying the two-dimensional image and the volume rendered projection.

19. A program element for reconstructing an image of an object under examination, which program, when executed by a processor, is adapted to control a method comprising:
receiving a first projection data set representing three-dimensional information about said object under examination;
reconstructing at least one three-dimensional image out of the first projection data set;
receiving a second projection data set representing two-dimensional information about the object under examination, wherein the second data set was recorded at a first direction;
reconstructing a volume rendered projection out of the at least one three-dimensional image using the first direction as the reconstruction direction of the volume rendered projection;
generating a two-dimensional image out of the second projection data set; and
overlaying the two-dimensional image and the volume rendered projection.
